(19) United States
(12) Patent Application Publication
(10) Pub. No.: US 2026/0111773 A1
(43) Pub. Date: Apr. 23, 2026

(54) OBSCURING PROPRIETARY INFORMATION IN QUANTUM CIRCUITS USING VIRTUAL QUANTUM GATES

(71) Applicant: International Business Machines Corporation, Armonk, NY (US)

(72) Inventors: Derek Wang, New York, NY (US); Ali Javadiabhari, Sleepy Hollow, NY (US); Alireza Seif Tabrizi, Adelphi, MD (US)

(21) Appl. No.: 18/919,322

(22) Filed: Oct. 17, 2024

(51) Int. Cl. G06N 10/20; G06N 10/40

(52) U.S. Cl. CPC G06N 10/20; G06N 10/40

(57) ABSTRACT

A method, system, and computer program product for obscuring proprietary information encoded in quantum circuits. The target quantum circuit and the identification of the proprietary information of the target quantum circuit to be obscured are received. Examples of proprietary information include, but are not limited to, a circuit structure, a measurement outcome, an initial product state of qubits, and parameters to be bound in the target quantum circuit. The target quantum circuit is transformed into a power-attack resistant quantum circuit by encoding the proprietary information in virtual quantum gates which are not executed on quantum hardware whose logical effects are tracked classically. Such virtual quantum gates require no power. As a result, proprietary information encoded in the virtual quantum gates cannot be detected via a power side-channel attack. In this manner, proprietary information encoded in quantum circuits is prevented from being stolen by power side-channel attacks.

### TECHNICAL FIELD

The present disclosure relates generally to power side-channel attacks on quantum computer controllers, and more particularly to obscuring proprietary information in quantum circuits using virtual quantum gates.

### BACKGROUND

The interest in quantum computing is growing rapidly and already a large number of quantum computers are easily accessible over the Internet to researchers and everyday users. Due to the expensive nature of the quantum computing equipment, these computers are currently available as cloud-based systems. Remote access makes it easy for different users and companies to run algorithms on real quantum computers without the need to purchase or maintain them.

However, there is a threat of malicious insiders within the data centers or cloud computing facilities to access the quantum computers and the microwave controllers (device that uses microwaves to control quantum bits or qubits) thereby leveraging physically collected information to steal or leak the proprietary information in the quantum circuits.

One such method is using what is referred to as “power side-channel attacks,” such as on the quantum computer controllers (e.g., microwave controllers). Power side-channel attacks are a type of physical attack that can be used to extract proprietary information (any type of data that the owner wishes to restrict who knows about it or its contents). These attacks exploit the control pulses from the quantum computer controllers (e.g., microwave controllers) that quantum computers use to execute gate operations, which are fully classical and can be monitored. For example, attackers can measure the power consumption of the controller devices that send the microwave pulses to the quantum computer. The measured power consumption enables the attacker to recover information about the control pulses, which can then be used to reverse engineer proprietary information (e.g., algorithms being run, structure of quantum circuit) encoded in the quantum circuit executed on the quantum hardware. For example, the attacker may use per-channel single trace information to perform a brute-force attack with the goal of reconstructing the quantum program.

Unfortunately, there is not currently a means for preventing the theft of proprietary information encoded in quantum circuits executed on quantum hardware.

### SUMMARY

In one embodiment of the present disclosure, a method for obscuring proprietary information encoded in quantum circuits comprises receiving a target quantum circuit. The method further comprises receiving an identification of the proprietary information of the targeted quantum circuit to be obscured. The method additionally comprises transforming the target quantum circuit into a power-attack resistant quantum circuit by encoding the proprietary information in virtual quantum gates which are not executed on quantum hardware whose logical effects are tracked classically.

Furthermore, in one embodiment of the present disclosure, the proprietary information comprises one of the following in the group consisting of: a circuit structure, a measurement outcome, an initial product state of qubits, and parameters to be bound in the target quantum circuit.

Additionally, in one embodiment of the present disclosure, the virtual quantum gates encode a circuit structure of the target quantum circuit by converting the target quantum circuit into dense layers of two-qubit and one-qubit gates. The dense layers of two-qubit and one-qubit gates are formed by inserting two-qubit gates to form a two-qubit dense layer, and inserting dense one-qubit layers of alternating virtual quantum gates and non-virtual quantum gates to ensure the power-attack resistant quantum circuit is identical to the target quantum circuit.

Furthermore, in one embodiment of the present disclosure, the virtual quantum gates encode a measurement outcome by randomly inserting X gates before one or more measurement operations, wherein each X gate is decomposed into alternating layers of virtual quantum gates and non-virtual quantum gates.

Additionally, in one embodiment of the present disclosure, the virtual quantum gates encode an initial product state of qubits by inserting X gates at a beginning of the target quantum circuit which are decomposed into alternating layers of virtual quantum gates and non-virtual quantum gates to obfuscate an initial basis of each qubit.

Furthermore, in one embodiment of the present disclosure, the virtual quantum gates encode parameters to be bound in the target quantum circuit by decomposing each parameterized gate into a series of quantum gates comprising a virtual quantum gate.

Additionally, in one embodiment of the present disclosure, the virtual quantum gates comprise one of the following in the group consisting of: an X gate, an Rx gate, an Rz gate, and a SWAP gate.

Other forms of the embodiments of the method described above are in a system and in a computer program product.

Accordingly, embodiments of the present disclosure prevent proprietary information encoded in the quantum circuits from being stolen by power side-channel attacks.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for obscuring proprietary information encoded in quantum circuits so as to prevent the theft of such proprietary information by power side-channel attacks in accordance with an embodiment of the present disclosure;

FIGS. 3A-3C illustrate encoding the proprietary information in virtual quantum gates corresponding to the circuit structure in accordance with an embodiment of the present disclosure;

FIGS. 4A-4C illustrate randomly adding the canonical identity sparsely in the power-attack resistant quantum circuit in accordance with an embodiment of the present disclosure;

FIGS. 5A-5C illustrate encoding the proprietary information in virtual quantum gates corresponding to a measurement outcome in accordance with an embodiment of the present disclosure;

FIGS. 6A-6B illustrate encoding proprietary information in virtual quantum gates corresponding to the initial state of the qubits in accordance with an embodiment of the present disclosure;

FIGS. 7A-7B illustrate encoding the proprietary information in virtual quantum gates corresponding to the parameters to be bound in the quantum circuit in accordance with an embodiment of the present disclosure;

FIG. 8 illustrates an embodiment of the present disclosure of the hardware configuration of the classical computer which is representative of a hardware environment for practicing the present disclosure; and

FIG. 9 is a flowchart of a method for obscuring proprietary information encoded in quantum circuits so as to prevent the theft of such proprietary information by power side-channel attacks in accordance with an embodiment of the present disclosure.

### DETAILED DESCRIPTION

In one embodiment of the present disclosure, a method for obscuring proprietary information encoded in quantum circuits comprises receiving a target quantum circuit. The method further comprises receiving an identification of the proprietary information of the targeted quantum circuit to be obscured. The method additionally comprises transforming the target quantum circuit into a power-attack resistant quantum circuit by encoding the proprietary information in virtual quantum gates which are not executed on quantum hardware whose logical effects are tracked classically.

In this manner, proprietary information encoded in the quantum circuits is prevented from being stolen by power side-channel attacks.

Furthermore, in one embodiment of the present disclosure, the proprietary information comprises one of the following in the group consisting of: a circuit structure, a measurement outcome, an initial product state of qubits, and parameters to be bound in the target quantum circuit.

In this manner, the particular type of proprietary information encoded in the quantum circuit can be designated for protection against power side-channel attacks.

Additionally, in one embodiment of the present disclosure, the virtual quantum gates encode a circuit structure of the target quantum circuit by converting the target quantum circuit into dense layers of two-qubit and one-qubit gates. The dense layers of two-qubit and one-qubit gates are formed by inserting two-qubit gates to form a two-qubit dense layer, and inserting dense one-qubit layers of alternating virtual quantum gates and non-virtual quantum gates to ensure the power-attack resistant quantum circuit is identical to the target quantum circuit.

In this manner, proprietary information corresponding to the circuit structure can be protected against power side-channel attacks.

Furthermore, in one embodiment of the present disclosure, the virtual quantum gates encode a measurement outcome by randomly inserting X gates before one or more measurement operations, wherein each X gate is decomposed into alternating layers of virtual quantum gates and non-virtual quantum gates.

In this manner, proprietary information corresponding to the measurement outcomes can be protected against power side-channel attacks.

Additionally, in one embodiment of the present disclosure, the virtual quantum gates encode an initial product state of qubits by inserting X gates at a beginning of the target quantum circuit which are decomposed into alternating layers of virtual quantum gates and non-virtual quantum gates to obfuscate an initial basis of each qubit.

In this manner, proprietary information corresponding to the initial product state of qubits can be protected against power side-channel attacks.

Furthermore, in one embodiment of the present disclosure, the virtual quantum gates encode parameters to be bound in the target quantum circuit by decomposing each parameterized gate into a series of quantum gates comprising a virtual quantum gate.

In this manner, proprietary information corresponding to the parameters to be bound in the target quantum circuit can be protected against power side-channel attacks.

Additionally, in one embodiment of the present disclosure, the virtual quantum gates comprise one of the following in the group consisting of: an X gate, an Rx gate, an Rz gate, and a SWAP gate.

In this manner, various types of virtual quantum gates may be utilized for encoding proprietary information.

Other forms of the embodiments of the method described above are in a system and in a computer program product.

As stated above, the interest in quantum computing is growing rapidly and already a large number of quantum computers are easily accessible over the Internet to researchers and everyday users. Due to the expensive nature of the quantum computing equipment, these computers are currently available as cloud-based systems. Remote access makes it easy for different users and companies to run algorithms on real quantum computers without the need to purchase or maintain them.

However, there is a threat of malicious insiders within the data centers or cloud computing facilities to access the quantum computers and the microwave controllers (device that uses microwaves to control quantum bits or qubits) thereby leveraging physically collected information to steal or leak the proprietary information in the quantum circuits.

One such method is using what is referred to as “power side-channel attacks,” such as on the quantum computer controllers (e.g., microwave controllers). Power side-channel attacks are a type of physical attack that can be used to extract proprietary information (any type of data that the owner wishes to restrict who knows about it or its contents). These attacks exploit the control pulses from the quantum computer controllers (e.g., microwave controllers) that quantum computers use to execute gate operations, which are fully classical and can be monitored. For example, attackers can measure the power consumption of the controller devices that send the microwave pulses to the quantum computer. The measured power consumption enables the attacker to recover information about the control pulses, which can then be used to reverse engineer proprietary information (e.g., algorithms being run, structure of quantum circuit) encoded in the quantum circuit executed on the quantum hardware. For example, the attacker may use per-channel single trace information to perform a brute-force attack with the goal of reconstructing the quantum program.

Unfortunately, there is not currently a means for preventing the theft of proprietary information encoded in quantum circuits executed on quantum hardware.

The embodiments of the present disclosure provide the means for obscuring proprietary information (e.g., circuit structure, measurement outcome, an initial product state of the qubits, parameters to be bound in the quantum circuit) encoded in quantum circuits by utilizing virtual quantum gates to encode the proprietary information in the quantum circuit. Virtual quantum gates, as used herein, refer to quantum gates which are not executed on quantum hardware whose logical effects are tracked classically. Such virtual quantum gates require no power. As a result, a target quantum circuit, which refers to the quantum circuit desired to have its proprietary information protected from power side-channel attacks, is transformed into a power-attack resistant quantum circuit by encoding the proprietary information in the virtual quantum gates. For example, the virtual quantum gates encode a measurement outcome by randomly inserting X gates before the measurement operations, where each X gate is decomposed into alternating layers of virtual quantum gates and non-virtual quantum gates. Examples of virtual quantum gates include, but are not limited to, the X gate, the Rx gate, the Rz gate, and the SWAP gate. In this manner, proprietary information encoded in the quantum circuits is prevented from being stolen by power side-channel attacks. These and other features will be discussed in further detail below.

In some embodiments of the present disclosure, the present disclosure comprises a method, system, and computer program product for obscuring proprietary information encoded in quantum circuits. In one embodiment of the present disclosure, the target quantum circuit and the identification of the proprietary information of the target quantum circuit to be obscured are received. The target quantum circuit, as used herein, refers to the quantum circuit desired to have its proprietary information protected from power side-channel attacks. Proprietary information, as used herein, refers to any type of data that the owner wishes to restrict who knows about it or its contents. Examples of proprietary information include, but are not limited to, a circuit structure, a measurement outcome, an initial product state of qubits, and parameters to be bound in the target quantum circuit. The target quantum circuit is transformed into a power-attack resistant quantum circuit by encoding the proprietary information in virtual quantum gates. The proprietary information is encoded in virtual quantum gates in various manners depending upon the particular proprietary information to be obscured. Virtual quantum gates, as used herein, refer to quantum gates which are not executed on quantum hardware whose logical effects are tracked classically. Such virtual quantum gates require no power. Examples of virtual quantum gates include, but are not limited to, the X gate, the Rx gate, the Rz gate, and the SWAP gate. As a result, proprietary information encoded in the virtual quantum gates cannot be detected via a power side-channel attack. In this manner, proprietary information encoded in quantum circuits is prevented from being stolen by power side-channel attacks.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

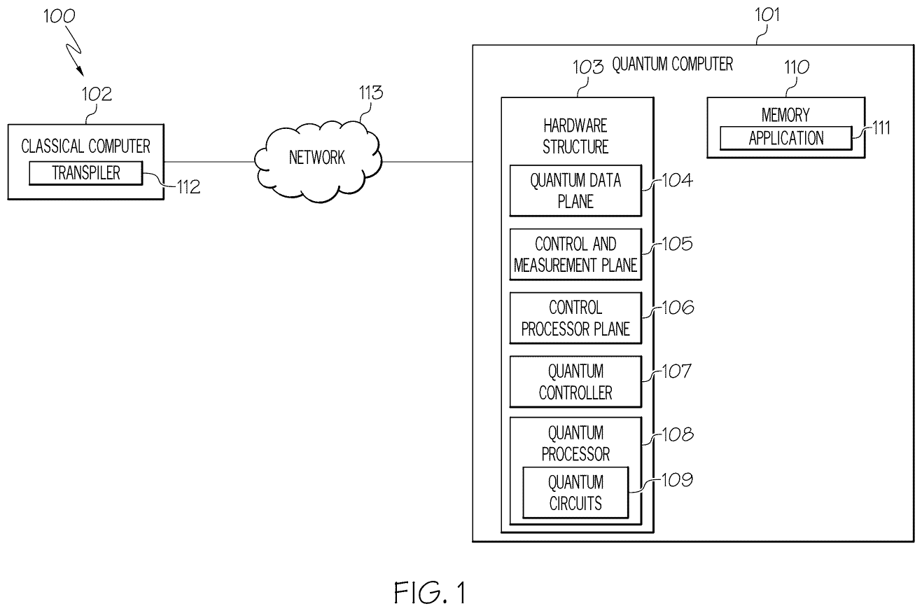

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to obscure proprietary information encoded in quantum circuits so as to prevent the theft of such proprietary information by power side-channel attacks.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits'state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring”network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (also identified as Rx) (performs e^{iθX/2}, which corresponds to a rotation of the qubit state around the X-axis by the given angle theta θ on the Bloch sphere), RY (also identified as Ry) (performs e^{iθY/2}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

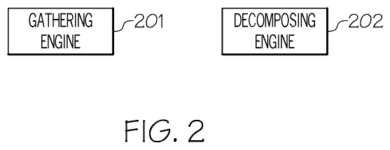

In one embodiment, memory 110 stores an application 111 that may be configured to implement one or more of the methods described herein in accordance with one or more embodiments. For example, application 111 may implement a program for obscuring proprietary information encoded in quantum circuits so as to prevent the theft of such proprietary information by power side-channel attacks as discussed further below in connection with FIGS. 2, 3A-3C, 4A-4C, 5A-5C, 6A-6B, 7A-7B and 9. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit. transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, quantum machine learning models are based on variational quantum circuits 109. Such models consist of data encoding, processing parameterized with trainable parameters, and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features) * (number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

Furthermore, classical computer 102 is configured to obscure proprietary information encoded in quantum circuits so as to prevent the theft of such proprietary information by power side-channel attacks as discussed further below in connection with FIGS. 2, 3A-3C, 4A-4C, 5A-5C, 6A-6B, 7A-7B and 9. A description of the software components of classical computer 102 is provided below in connection with FIG. 2 and a description of the hardware configuration of classical computer 102 is provided further below in connection with FIG. 8.

System 100 is not to be limited in scope to any one particular network architecture. System 100 may include any number of quantum computers 101, classical computers 102, and networks 113.

A discussion regarding the software components used by classical computer 102 for obscuring proprietary information encoded in quantum circuits so as to prevent the theft of such proprietary information by power side-channel attacks is provided below in connection with FIG. 2.

FIG. 2 is a diagram of the software components of classical computer 102 (FIG. 1) for obscuring proprietary information encoded in quantum circuits so as to prevent the theft of such proprietary information by power side-channel attacks in accordance with an embodiment of the present disclosure.

It is noted that the components discussed herein in connection with FIG. 2 may reside within a compiler, including a program that translates high-level quantum algorithms written in a programing language into low-level instructions that can be directly executed on quantum hardware 103 (FIG. 1)

Referring to FIG. 2, in conjunction with FIG. 1, classical computer 102 includes gathering engine 201 configured to receive the target quantum circuit and the identification of the proprietary information of the target quantum circuit to be obscured. The target quantum circuit, as used herein, refers to the quantum circuit desired to have its proprietary information protected from power side-channel attacks. Proprietary information, as used herein, refers to any type of data that the owner wishes to restrict who knows about it or its contents. Examples of proprietary information include, but are not limited to, a circuit structure, a measurement outcome, an initial product state of qubits, and parameters to be bound in the quantum circuit, such as the target quantum circuit.

In one embodiment, gathering engine 201 receives the target quantum circuit to be protected against power side-channel attacks by a user of classical computer 102 inputting such information into classical computer 102, such as by the user creating the target quantum circuit. For example, a user of classical computer 102 may create the target circuit to be protected against power side-channel attacks using the QuantumCircuit function of Qiskit®, such as to specify the number of qubits and classical bits to include in the circuit. Furthermore, instructions that act on such qubits are then appended to the circuit's data attributes, such as via the QuantumCircuit.h and QuantumCircut.cx methods of Qiskit®. Other tools utilized by a user of classical computer 102 to create the target quantum circuit to be protected against power side-channel attacks include, but are not limited to, Cirq®, ProjectQ, Quantum Composer, etc.

In one embodiment, gathering engine 201 receives the identification of the proprietary information of the target quantum circuit to be obscured from a user, such as a user of classical computer 102. In one embodiment, gathering engine 201 receives the identification of the proprietary information to be obscured by the user selecting a category of proprietary information (e.g., circuit structure, measurement outcome, initial product state of qubits, and parameters to be bound in the target quantum circuit) out of a listing of categories of proprietary information displayed in a menu to the user, such as on the display of classical computer 102.

In one embodiment, gathering engine 201 may receive such identification of the proprietary information of the target quantum circuit to be obscured from a user inputting such information via various software tools, such as, but are not limited to, Quantum Composer, ProjectQ, etc.

Classical computer 102 further includes decomposing engine 202 configured to transform the target quantum circuit into a power-attack resistant quantum circuit by encoding the proprietary information in virtual quantum gates. A power-attack resistant quantum circuit, as used herein, refers to a quantum circuit that prevents the theft of proprietary information encoded in the quantum circuit by power side-channel attacks. Virtual quantum gates, as used herein, refer to quantum gates which are not executed on quantum hardware whose logical effects are tracked classically. Such virtual quantum gates require no power. Examples of such virtual quantum gates include, but are not limited to, the X gate, the Rx gate (also identified as the RX gate), the Rz gate (also identified as the RZ gate), and the SWAP gate. As a result, proprietary information encoded in the virtual quantum gates cannot be detected via a power side-channel attack.

Decomposing engine 202 transforms the target quantum circuit into a power-attack resistant quantum circuit by encoding the proprietary information in virtual quantum gates in various manners depending upon the particular proprietary information to be obscured.

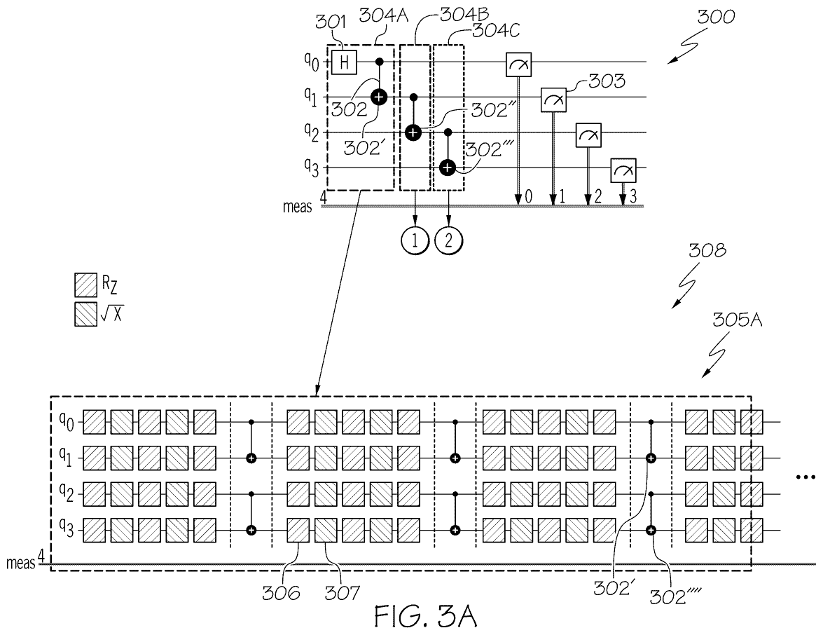

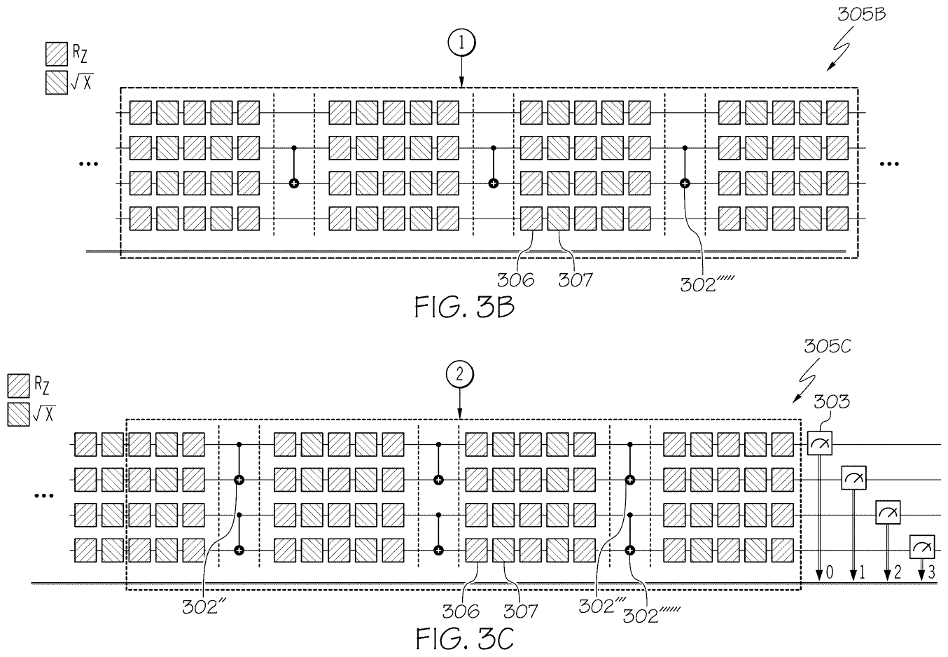

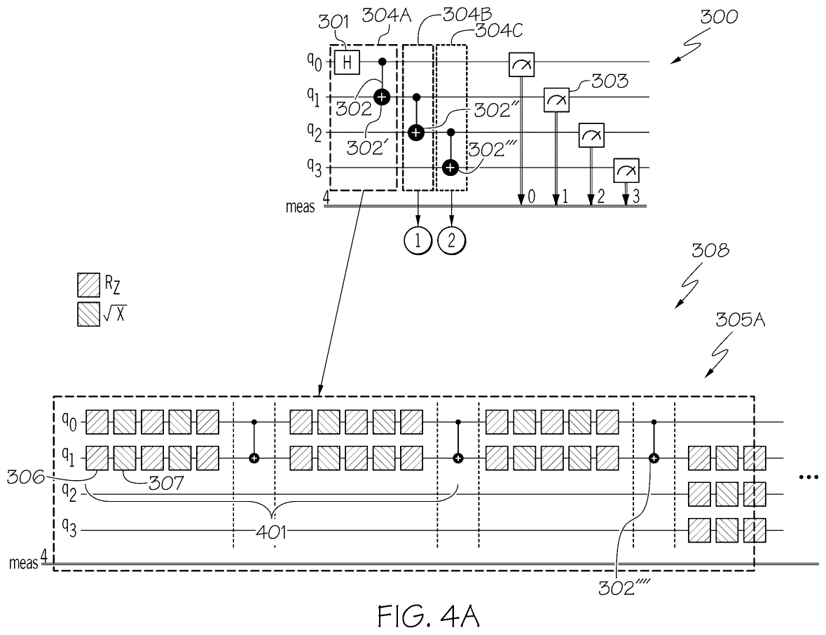

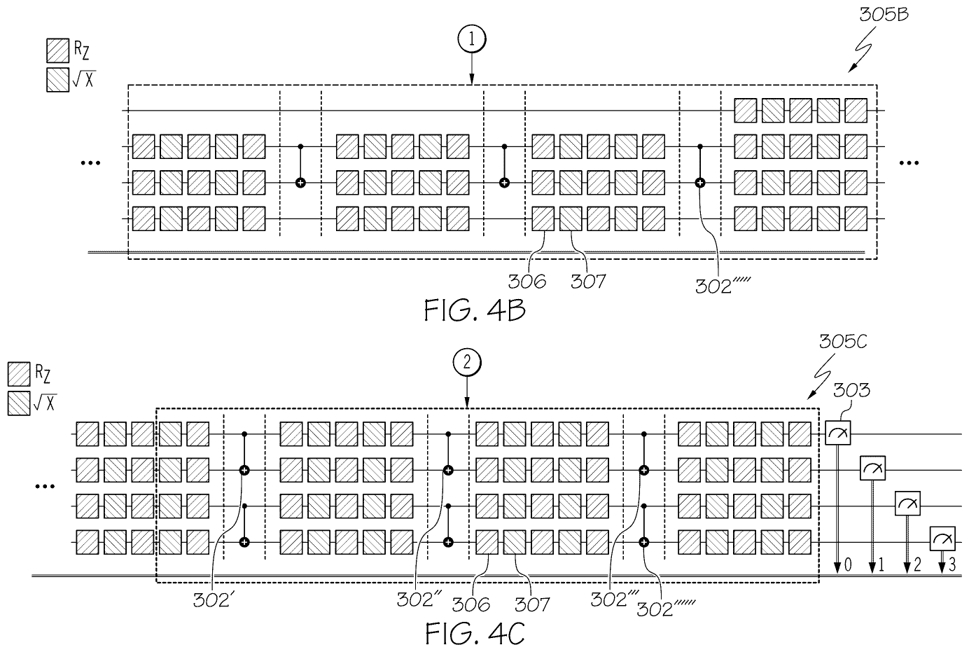

For example, for proprietary information corresponding to the circuit structure, virtual quantum gates encode the circuit structure of the target quantum circuit by converting the target quantum circuit into dense layers of two-qubit and one-qubit gates. In one embodiment, the dense layers of the two-qubit and one-qubit gates are formed by inserting two-qubit gates to form a two-qubit dense layer and inserting dense one-qubit layers of alternating virtual quantum gates and non-virtual quantum gates to ensure that the power-attack resistant quantum circuit is identical to the target quantum circuit as discussed further below in connection with FIGS. 3A-3C and 4A-4C.

In connection with obscuring the circuit structure, it is noted that any single-qubit operation can be decomposed into Rz-SX-Rz-SX-Rz gates, where the Rz gate, which is a virtual quantum gate, is a single-qubit rotation through an angle θ (radians) around the z-axis, and where the SX gate is the single-qubit Sqrt(X) gate. Furthermore, any two-qubit operation (e.g., Controlled-NOT (CNOT) gate) can be decomposed into 3 CNOT gates with single qubit gates in between. An illustration of such a decomposition is provided in FIGS. 3A-3C which is discussed further below. Additionally, single-qubit identity and two-qubit identity gates also have such decompositions.

Referring now to FIGS. 3A-3C, FIGS. 3A-3C illustrate encoding the proprietary information in virtual quantum gates corresponding to the circuit structure in accordance with an embodiment of the present disclosure.

As shown in FIGS. 3A-3C, quantum circuit 300 includes a Hadamard (H) gate 301 and CNOT gates 302, the measurements of which are evaluated by measurement operations 303. In one embodiment, such CNOT gates 302 perform two-qubit operations, where such two-qubit operations may be decomposed into 3 CNOT gates with single qubit gates in between as shown in FIGS. 3A-3C. Furthermore, such single-qubit operations may be decomposed into Rz-SX-Rz-SX-Rz gates as also shown in FIGS. 3A-3C.

In one embodiment, such decompositions are implemented by decomposing engine 202 after identifying the unique circuit layers of quantum circuit 300. For example, decomposing engine 202 identifies the unique circuit layers 304A-304C of quantum circuit 300. Circuit layers 304A-304C may collectively or individually be referred to as circuit layers 304 (or unique circuit layers 304) or circuit layer 304 (or unique circuit layer 304), respectively. A circuit layer, such as circuit layer 304, as used herein, refers to sequence of gates that act on disjoint qubits.

In one embodiment, decomposing engine 202 identifies the unique circuit layers 304 of quantum circuit 300 by breaking down quantum circuit 300 into alternating sequences of CNOT gates 302. Each CNOT sequence creates a layer of qubit functional configuration. The sequence of layers defines the unique type of quantum circuit. In one embodiment, decomposing engine 202 utilizes various software tools to identify the unique circuit layers 304 of quantum circuit 300 in this manner, such as, but are not limited to, Cirq®, QuCAT, Qiskit®, etc.

In one embodiment, a circuit layer with a structure that is to be hidden from an attacker is buried in a denser circuit layer that is identical logically. As a result, in one embodiment, circuit layers, such as circuit layers 304A-304C, are matched with template circuit layers 305A-305C, respectively. Template circuit layers 305A-305C may collectively or individually be referred to as template circuit layers 305 or template circuit layer 305, respectively. Template circuit layer 305 in a quantum circuit, as used herein, is s sequence of quantum gates that is repeated. In one embodiment, such template layers 305 contain the decompositions discussed above.

For instance, CNOT gate 302′ in circuit layer 304A is decomposed into 3 CNOT gates 302″″ with Rz-SX-Rz-SX-Rz gates (Rz quantum gates 306, SX quantum gates 307) in between. In one embodiment, such a decomposition occurs in template circuit layer 305A of power-attack resistant quantum circuit 308.

In another example, CNOT gate 302″ is decomposed into 3 CNOT gates 302″″′ with Rz-SX-Rz-SX-Rz gates (Rz quantum gates 306, SX quantum gates 307) in between. In one embodiment, such a decomposition occurs in template circuit layer 305B of power-attack resistant quantum circuit 308.

In a further example, CNOT gate 302″′ is decomposed into 3 CNOT gates 302″″″ with Rz-SX-Rz-SX-Rz gates (Rz quantum gates 306, SX quantum gates 307) in between. In one embodiment, such a decomposition occurs in template circuit layer 305C of power-attack resistant quantum circuit 308.

In one embodiment, decomposing engine 202 recompiles the unique circuit layers 304 into template circuit layers 305 so that CNOT gates 302′, 302″, and 302′″ of unique circuit layers 304 are intermixed with the decomposed CNOT gates 302″″, 302″″′, and 302″″″ as shown in FIGS. 3A-3C.

In one embodiment, decomposing engine 202 transforms the target quantum circuit (e.g., target quantum circuit 300) into a power-attack resistant quantum circuit (e.g., power-attack resistant quantum circuit 308) by encoding the proprietary information, such as the circuit structure, in the virtual quantum gates by transpiling the target quantum circuit into a sequence of 1-qubit and 2-qubit gates of the power-attack resistant quantum circuit. The power-attack resistant quantum circuit is then made to follow regular layers, such as having each layer be a maximal matching on the hardware graph. In one embodiment, the power-attack resistant quantum circuit is made to follow regular layers by inserting 2-qubit identity operations to make the layers full. Furthermore, decomposing engine 202 collects 2-qubit operations and writes them as generic SU(4) gates (SU(4) is a particular unitary group) in every layer. Each SU(4) gate is decomposed using the universal decomposition [SU(2)⊗SU(2)]CX [SU(2)⊗SU(2)]CX [SU(2)⊗SU(2)]CX [SU(2)⊗SU(2)]. It is noted that all two-qubit operations now have the same form (even the identity operation). Decomposing engine 202 further collects 1-qubit operations and writes them as generic SU(2) gates (SU(2) is a particular unitary group). Such SU(2) gates are decomposed using the universal decomposition RZ. SX. RZ. SX. RZ thereby resulting in an obfuscated circuit. Such a circuit has the same pulses regardless of the underlying computation.

In one embodiment, in addition to obfuscating, the non-virtual quantum gates required for obfuscation may reduce the fidelity (measure of the accuracy and reliability of a qubit or a quantum operation) of the computation when gates are noisy. As a result, there may be a tradeoff between security and fidelity of the quantum circuit. Hence, the target quantum circuit may be partially obfuscated so as to maintain the fidelity of the quantum circuit. In one embodiment, decomposing engine 202 still uses the canonical decomposition for the gate in the target quantum circuit but also randomly adds the canonical identity 401 sparsely as shown in FIGS. 4A-4C. Canonical identity 401, as used herein, refers to the operations of the circuit structure of the target quantum circuit, such as target quantum circuit 300, that are not obfuscated.

FIGS. 4A-4C illustrate randomly adding the canonical identity sparsely in the power-attack resistant quantum circuit in accordance with an embodiment of the present disclosure.

As shown in FIGS. 4A-4C, decomposing engine 202 randomly adds canonical identity 401 sparsely in order to not obfuscate such a portion of the circuit structure of the target quantum circuit, such as target quantum circuit 300, so as to maintain fidelity of the quantum circuit. For example, only a portion of the circuit structure of the target quantum circuit may be obscured as opposed to the entirety of the target quantum circuit so as to not introduce too much noise due to quantum gates being noisy.

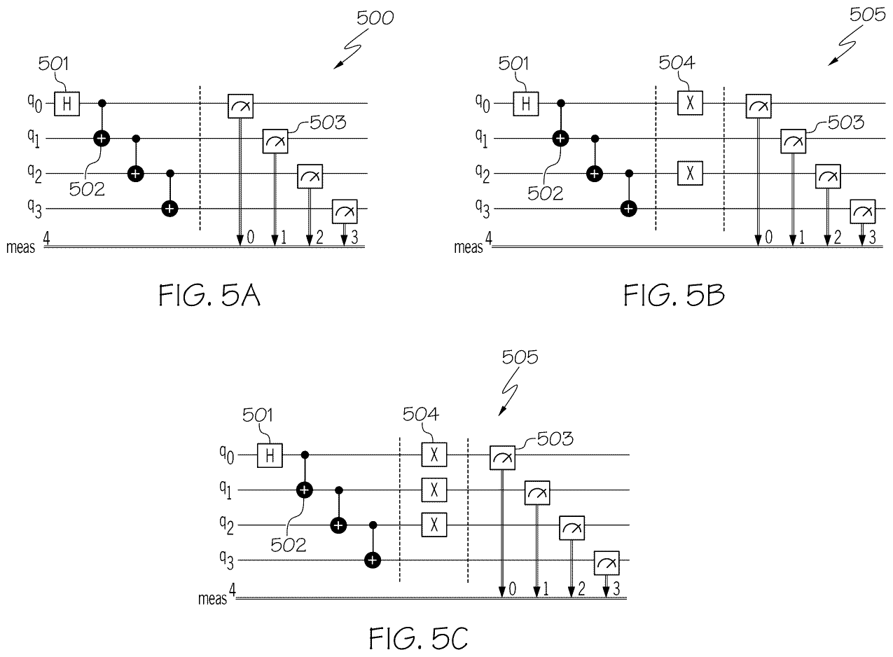

For proprietary information corresponding to the measurement outcome, in one embodiment, decomposing engine 202 transforms the target quantum circuit into a power-attack resistant quantum circuit by encoding the proprietary information, such as a measurement outcome, in virtual quantum gates by randomly inserting X gates before measurement operations, where each X gate is decomposed into alternating layers of virtual quantum gates and non-virtual quantum gates (e.g., Rz-SX-Rz-SX-Rz, where Rz quantum gates are virtual quantum gates and SX quantum gates are non-virtual quantum gates) as discussed below in connection with FIGS. 5A-5C.

FIGS. 5A-5C illustrate encoding the proprietary information in virtual quantum gates corresponding to a measurement outcome in accordance with an embodiment of the present disclosure.

Referring to FIGS. 5A-5C, measurement outcomes are determined by measurements performed by measurement operations. Measurement outcomes are binary strings that contain proprietary information. In one embodiment, decomposing engine 202 utilizes a one-time pad (i.e., adding another known binary string to hide the results) to encrypt the measurements using the computational circuit. In such an embodiment, the quantum circuit does not change.

For example, FIG. 5A illustrates target quantum circuit 500 with a Hadamard (H) gate 501 and CNOT gates 502, the measurements of which are evaluated by measurement operations 503. Decomposing engine 202 transforms target quantum circuit 500 into power-attack resistant quantum circuit 505 by applying the X gate 504 before the measurements thereby flipping the bits in the measurement outcome as shown FIGS. 5B and 5C. Furthermore, each X gate 504 is decomposed into alternating layers of virtual quantum gates (e.g., Rz quantum gates 306) and non-virtual quantum gates (SX quantum gates 307) as previously discussed in connection with FIGS. 3A-3C.

Prior to retrieving such measurements, decomposing engine 202 flips the results locally after retrieving them thereby providing the appropriate measurements.

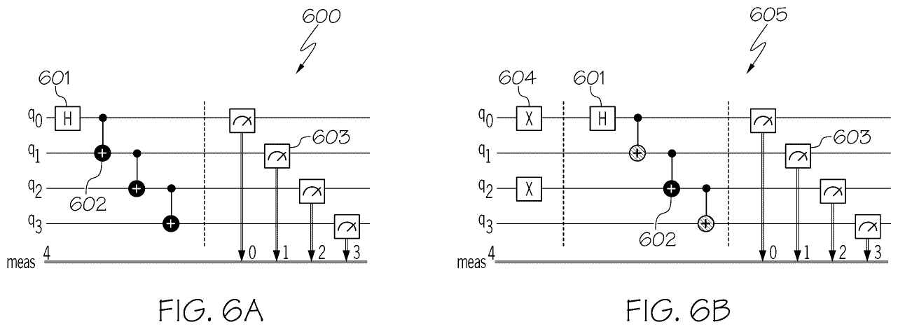

For proprietary information corresponding to the initial product state of the qubits, in one embodiment, decomposing engine 202 transforms the target quantum circuit into a power-attack resistant quantum circuit by encoding the proprietary information, such as the initial product state of the qubits, in virtual quantum gates by inserting X gates which are decomposed into alternating layers of virtual quantum gates and non-virtual quantum gates as discussed below in connection with FIGS. 6A-6B.

FIGS. 6A-6B illustrate encoding proprietary information in virtual quantum gates corresponding to the initial state of the qubits in accordance with an embodiment of the present disclosure.

Referring to FIGS. 6A-6B, the initial state of the qubit may contain proprietary information, such as test data. In one embodiment, decomposing engine 202 obfuscates such proprietary information from power side-channel attacks by inserting X gates at the beginning of the target quantum, which are decomposed into alternating layers of virtual quantum gates and non-virtual quantum gates to obfuscate the initial basis of each qubit.

For instance, FIG. 6A illustrates target quantum circuit 600 with a Hadamard (H) gate 601 and CNOT gates 602, the measurements of which are evaluated by measurement operations 603. Decomposing engine 202 transforms target quantum circuit 600 into power-attack resistant quantum circuit 605 by inserting X gates 604, at the beginning of target quantum circuit 600, which are decomposed into alternating layers of virtual quantum gates (e.g., Rz quantum gates 306) and non-virtual quantum gates (SX quantum gates 307) as previously discussed in connection with FIGS. 3A-3C. By utilizing virtual quantum gates which do not use power, the proprietary information, such as the initial state of the qubit, is protected from theft by a power side-channel attack.

However, since in this embodiment, X gates 604 are utilized, the corresponding bits in the input are flipped. As a result, in such an embodiment, decomposing engine 202 changes the definition of 0 and 1 for those input bits that where flipped by X gates 604 in order to obtain the correct measurements by measurement operations 603. Furthermore, in such an embodiment as shown in FIGS. 6A-6B, the quantum circuit does not change.

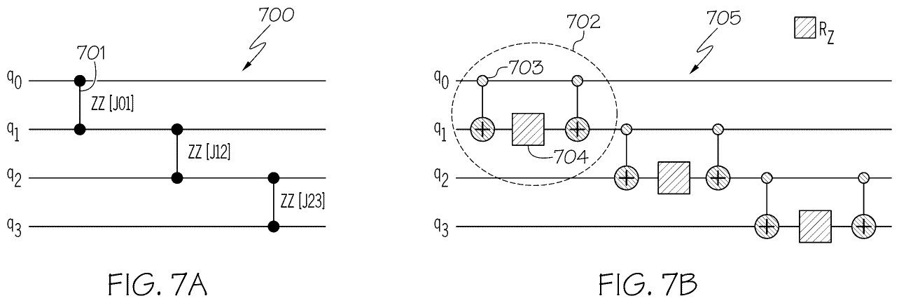

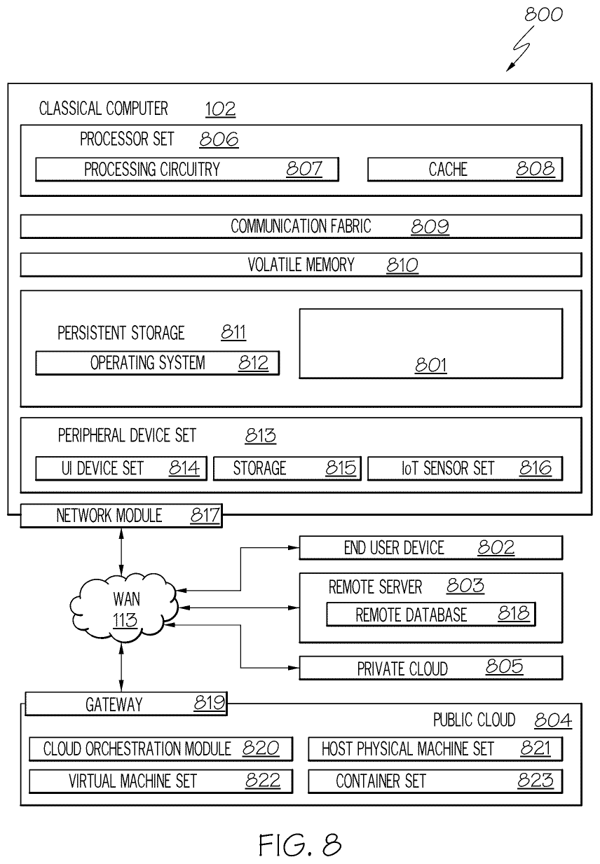

For proprietary information corresponding to the parameters to be bound in the quantum circuit, in one embodiment, decomposing engine 202 transforms the target quantum circuit into a power-attack resistant quantum circuit by encoding the proprietary information, such as the parameters to be bound in the quantum circuit, in virtual quantum gates by decomposing each parameterized gate into a series of quantum gates including a virtual quantum gate as discussed below in connection with FIGS. 7A-7B.

FIGS. 7A-7B illustrate encoding the proprietary information in virtual quantum gates corresponding to the parameters to be bound in the quantum circuit in accordance with an embodiment of the present disclosure.

Referring to FIGS. 7A-7B, in certain cases, the values of the parameters to be bound in the quantum circuit contain proprietary information, such as via rotation angles corresponding to Hamiltonian coefficients, which point to which systems are being simulated. In one embodiment, decomposing engine 202 protects such parameters from being exposed by a power side-channel attack by folding them into a virtual gate.

For example, as shown in FIG. 7A, target quantum circuit 700 includes parameterized quantum gates 701, such as ZZ gates, which use a single parameter, θ, to set the phase of entanglement between two qubits (e.g., qubits q₀ and q₁). To protect the values of the parameters from parameterized quantum gates 701 that are to be bound in the quantum circuit from being exposed due to the power side-channel attack, decomposing engine 202 transforms target quantum circuit 700 into power-attack resistant quantum circuit 705 by decomposing each parameterized gate 701 into a series of quantum gates 702, including non-virtual quantum gates (e.g., CNOT gates 703) and a virtual quantum gate (e.g., Rz quantum gate 704), in power-attack resistant quantum circuit 705 thereby making parameters power attack-resistant. Such parameters are not subject to being exposed by a power side-channel attack since such virtual quantum gates do not use power.

In this manner, proprietary information encoded in the quantum circuits is prevented from being stolen by power side-channel attacks.

A further description of these and other functions is provided below in connection with the discussion of the method for obscuring proprietary information encoded in quantum circuits so as to prevent the theft of such proprietary information by power side-channel attacks.

Prior to the discussion of the method for obscuring proprietary information encoded in quantum circuits so as to prevent the theft of such proprietary information by power side-channel attacks, a description of the hardware configuration of classical computer 102 (FIG. 1) is provided below in connection with FIG. 8.

Referring now to FIG. 8, in conjunction with FIG. 1, FIG. 8 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code 801 involved in performing the inventive methods, such as obscuring proprietary information encoded in quantum circuits so as to prevent the theft of such proprietary information by power side-channel attacks. In addition to block 801, computing environment 800 includes, for example, classical computer 102, network 113, such as a wide area network (WAN), end user device (EUD) 802, remote server 803, public cloud 804, and private cloud 805. In this embodiment, classical computer 102 includes processor set 806 (including processing circuitry 807 and cache 808), communication fabric 809, volatile memory 810, persistent storage 811 (including operating system 812 and block 801, as identified above), peripheral device set 813 (including user interface (UI) device set 814, storage 815, and Internet of Things (IoT) sensor set 816), and network module 817. Remote server 803 includes remote database 818. Public cloud 804 includes gateway 819, cloud orchestration module 820, host physical machine set 821, virtual machine set 822, and container set 823.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 818. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically classical computer 102, to keep the presentation as simple as possible. Classical computer 102 may be located in a cloud, even though it is not shown in a cloud in FIG. 8. On the other hand, classical computer 102 is not required to be in a cloud except to any extent as may be affirmatively indicated.

Processor set 806 includes one, or more, computer processors of any type now known or to be developed in the future. Processing circuitry 807 may be distributed over multiple packages, for example, multiple, coordinated integrated circuit chips. Processing circuitry 807 may implement multiple processor threads and/or multiple processor cores. Cache 808 is memory that is located in the processor chip package(s) and is typically used for data or code that should be available for rapid access by the threads or cores running on processor set 806. Cache memories are typically organized into multiple levels depending upon relative proximity to the processing circuitry. Alternatively, some, or all, of the cache for the processor set may be located “off chip.” In some computing environments, processor set 806 may be designed for working with qubits and performing quantum computing.

Computer readable program instructions are typically loaded onto classical computer 102 to cause a series of operational steps to be performed by processor set 806 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 808 and the other storage media discussed below. The program instructions, and associated data, are accessed by processor set 806 to control and direct performance of the inventive methods. In computing environment 800, at least some of the instructions for performing the inventive methods may be stored in block 801 in persistent storage 811.

Communication fabric 809 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 810 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 810 is located in a single package and is internal to classical computer 102, but, alternatively or additionally, the volatile memory may be distributed over multiple packages and/or located externally with respect to classical computer 102.

Persistent Storage 811 is any form of non-volatile storage for computers that is now known or to be developed in the future. The non-volatility of this storage means that the stored data is maintained regardless of whether power is being supplied to classical computer 102 and/or directly to persistent storage 811. Persistent storage 811 may be a read only memory (ROM), but typically at least a portion of the persistent storage allows writing of data, deletion of data and re-writing of data. Some familiar forms of persistent storage include magnetic disks and solid state storage devices. Operating system 812 may take several forms, such as various known proprietary operating systems or open source Portable Operating System Interface type operating systems that employ a kernel. The code included in block 801 typically includes at least some of the computer code involved in performing the inventive methods.

Peripheral device set 813 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 814 may include components such as a display screen, speaker, microphone, wearable devices (such as goggles and smart watches), keyboard, mouse, printer, touchpad, game controllers, and haptic devices. Storage 815 is external storage, such as an external hard drive, or insertable storage, such as an SD card. Storage 815 may be persistent and/or volatile. In some embodiments, storage 815 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 816 is made up of sensors that can be used in Internet of Things applications. For example, one sensor may be a thermometer and another sensor may be a motion detector.

Network module 817 is the collection of computer software, hardware, and firmware that allows classical computer 102 to communicate with other computers through WAN 113. Network module 817 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 817 are performed on the same physical hardware device. In other embodiments (for example, embodiments that utilize software-defined networking (SDN)), the control functions and the forwarding functions of network module 817 are performed on physically separate devices, such that the control functions manage several different network hardware devices. Computer readable program instructions for performing the inventive methods can typically be downloaded to classical computer 102 from an external computer or external storage device through a network adapter card or network interface included in network module 817.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 802 is any computer system that is used and controlled by an end user (for example, a customer of an enterprise that operates classical computer 102), and may take any of the forms discussed above in connection with classical computer 102. EUD 802 typically receives helpful and useful data from the operations of classical computer 102. For example, in a hypothetical case where classical computer 102 is designed to provide a recommendation to an end user, this recommendation would typically be communicated from network module 817 of classical computer 102 through WAN 113 to EUD 802. In this way, EUD 802 can display, or otherwise present, the recommendation to an end user. In some embodiments, EUD 802 may be a client device, such as thin client, heavy client, mainframe computer, desktop computer and so on.

Remote server 803 is any computer system that serves at least some data and/or functionality to classical computer 102. Remote server 803 may be controlled and used by the same entity that operates classical computer 102. Remote server 803 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 818 of remote server 803.

Public cloud 804 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 804 is performed by the computer hardware and/or software of cloud orchestration module 820. The computing resources provided by public cloud 804 are typically implemented by virtual computing environments that run on various computers making up the computers of host physical machine set 821, which is the universe of physical computers in and/or available to public cloud 804. The virtual computing environments (VCEs) typically take the form of virtual machines from virtual machine set 822 and/or containers from container set 823. It is understood that these VCEs may be stored as images and may be transferred among and between the various physical machine hosts, either as images or after instantiation of the VCE. Cloud orchestration module 820 manages the transfer and storage of images, deploys new instantiations of VCEs and manages active instantiations of VCE deployments. Gateway 819 is the collection of computer software, hardware, and firmware that allows public cloud 804 to communicate through WAN 113.

Some further explanation of virtualized computing environments (VCEs) will now be provided. VCEs can be stored as “images. ” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 805 is similar to public cloud 804, except that the computing resources are only available for use by a single enterprise. While private cloud 805 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 804 and private cloud 805 are both part of a larger hybrid cloud.

Block 801 further includes the software components discussed above in connection with FIGS. 2, 3A-3C, 4A-4C, 5A-5C, 6A-6B and 7A-7B to obscure proprietary information encoded in quantum circuits so as to prevent the theft of such proprietary information by power side-channel attacks. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for obscuring proprietary information encoded in quantum circuits so as to prevent the theft of such proprietary information by power side-channel attacks, may be embodied in an application specific integrated circuit.

As stated above, the interest in quantum computing is growing rapidly and already a large number of quantum computers are easily accessible over the Internet to researchers and everyday users. Due to the expensive nature of the quantum computing equipment, these computers are currently available as cloud-based systems. Remote access makes it easy for different users and companies to run algorithms on real quantum computers without the need to purchase or maintain them. However, there is a threat of malicious insiders within the data centers or cloud computing facilities to access the quantum computers and the microwave controllers (device that uses microwaves to control quantum bits or qubits) thereby leveraging physically collected information to steal or leak the proprietary information in the quantum circuits. One such method is using what is referred to as “power side-channel attacks,” such as on the quantum computer controllers (e.g., microwave controllers). Power side-channel attacks are a type of physical attack that can be used to extract proprietary information (any type of data that the owner wishes to restrict who knows about it or its contents). These attacks exploit the control pulses from the quantum computer controllers (e.g., microwave controllers) that quantum computers use to execute gate operations, which are fully classical and can be monitored. For example, attackers can measure the power consumption of the controller devices that send the microwave pulses to the quantum computer. The measured power consumption enables the attacker to recover information about the control pulses, which can then be used to reverse engineer proprietary information (e.g., algorithms being run, structure of quantum circuit) encoded in the quantum circuit executed on the quantum hardware. For example, the attacker may use per-channel single trace information to perform a brute-force attack with the goal of reconstructing the quantum program. Unfortunately, there is not currently a means for preventing the theft of proprietary information encoded in quantum circuits executed on quantum hardware.

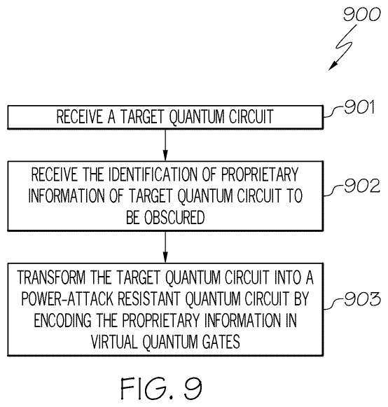

The embodiments of the present disclosure provide the means for obscuring proprietary information (e.g., circuit structure, measurement outcome, an initial product state of the qubits, parameters to be bound in the quantum circuit) encoded in quantum circuits by utilizing virtual quantum gates to encode the proprietary information in the quantum circuit as discussed below in connection with FIG. 9.

FIG. 9 is a flowchart of a method 900 for obscuring proprietary information encoded in quantum circuits so as to prevent the theft of such proprietary information by power side-channel attacks in accordance with an embodiment of the present disclosure.

Referring to FIG. 9, in conjunction with FIGS. 1-2, 3A-3C, 4A-4C, 5A-5C, 6A-6B, 7A-7B and 8, in step 901, gathering engine 201 of classical computer 102 receives a target quantum circuit.

As stated above, the target quantum circuit, as used herein, refers to the quantum circuit desired to have its proprietary information protected from power side-channel attacks. Proprietary information, as used herein, refers to any type of data that the owner wishes to restrict who knows about it or its contents. Examples of proprietary information include, but are not limited to, a circuit structure, a measurement outcome, an initial product state of qubits, and parameters to be bound in the quantum circuit, such as the target quantum circuit.

In one embodiment, gathering engine 201 receives the target quantum circuit to be protected against power side-channel attacks by a user of classical computer 102 inputting such information into classical computer 102, such as by the user creating the target quantum circuit. For example, a user of classical computer 102 may create the target circuit to be protected against power side-channel attacks using the QuantumCircuit function of Qiskit®, such as to specify the number of qubits and classical bits to include in the circuit. Furthermore, instructions that act on such qubits are then appended to the circuit's data attributes, such as via the QuantumCircuit.h and QuantumCircut.cx methods of Qiskit®. Other tools utilized by a user of classical computer 102 to create the target quantum circuit to be protected against power side-channel attacks include, but are not limited to, Cirq®, ProjectQ, Quantum Composer, etc.

In step 902, gathering engine 201 of classical computer 102 receives the identification of the proprietary information of the target quantum circuit to be obscured.

As discussed above, gathering engine 201 receives the identification of the proprietary information of the target quantum circuit to be obscured from a user, such as a user of classical computer 102. In one embodiment, gathering engine 201 receives the identification of the proprietary information to be obscured by the user selecting a category of proprietary information (e.g., circuit structure, measurement outcome, initial product state of qubits, and parameters to be bound in the target quantum circuit) out of a listing of categories of proprietary information displayed in a menu to the user, such as on the display of classical computer 102.

In one embodiment, gathering engine 201 may receive such identification of the proprietary information of the target quantum circuit to be obscured from a user inputting such information via various software tools, such as, but are not limited to, Quantum Composer, ProjectQ, etc.

In step 903, decomposing engine 202 of classical computer 102 transforms the target quantum circuit into a power-attack resistant quantum circuit by encoding the proprietary information in virtual quantum gates.

As stated above, a power-attack resistant quantum circuit, as used herein, refers to a quantum circuit that prevents the theft of proprietary information encoded in the quantum circuit by power side-channel attacks. Virtual quantum gates, as used herein, refer to quantum gates which are not executed on quantum hardware whose logical effects are tracked classically. Such virtual quantum gates require no power. Examples of such virtual quantum gates include, but are not limited to, the X gate, the Rx gate (also identified as the RX gate), the Rz gate (also identified as the RZ gate), and the SWAP gate. As a result, proprietary information encoded in the virtual quantum gates cannot be detected via a power side-channel attack.

Decomposing engine 202 transforms the target quantum circuit into a power-attack resistant quantum circuit by encoding the proprietary information in virtual quantum gates in various manners depending upon the particular proprietary information to be obscured.

For example, for proprietary information corresponding to the circuit structure, virtual quantum gates encode the circuit structure of the target quantum circuit by converting the target quantum circuit into dense layers of two-qubit and one-qubit gates. In one embodiment, the dense layers of the two-qubit and one-qubit gates are formed by inserting two-qubit gates to form a two-qubit dense layer and inserting dense one-qubit layers of alternating virtual quantum gates and non-virtual quantum gates to ensure that the power-attack resistant quantum circuit is identical to the target quantum circuit as discussed further below in connection with FIGS. 3A-3C and 4A-4C.

In connection with obscuring the circuit structure, it is noted that any single-qubit operation can be decomposed into Rz-SX-Rz-SX-Rz gates, where the Rz gate, which is a virtual quantum gate, is a single-qubit rotation through an angle θ (radians) around the z-axis, and where the SX gate is the single-qubit Sqrt(X) gate. Furthermore, any two-qubit operation (e.g., Controlled-NOT (CNOT) gate) can be decomposed into 3 CNOT gates with single qubit gates in between. An illustration of such a decomposition is provided in FIGS. 3A-3C. Additionally, single-qubit identity and two-qubit identity gates also have such decompositions.

For example, as shown in FIGS. 3A-3C, quantum circuit 300 includes a Hadamard (H) gate 301 and CNOT gates 302, the measurements of which are evaluated by measurement operations 303. In one embodiment, such CNOT gates 302 perform two-qubit operations, where such two-qubit operations may be decomposed into 3 CNOT gates with single qubit gates in between as shown in FIGS. 3A-3C. Furthermore, such single-qubit operations may be decomposed into Rz-SX-Rz-SX-Rz gates as also shown in FIGS. 3A-3C.

In one embodiment, such decompositions are implemented by decomposing engine 202 after identifying the unique circuit layers of quantum circuit 300. For example, decomposing engine 202 identifies the unique circuit layers 304A-304C of quantum circuit 300. Circuit layers 304A-304C may collectively or individually be referred to as circuit layers 304 (or unique circuit layers 304) or circuit layer 304 (or unique circuit layer 304), respectively. A circuit layer, such as circuit layer 304, as used herein, refers to sequence of gates that act on disjoint qubits.

In one embodiment, decomposing engine 202 identifies the unique circuit layers 304 of quantum circuit 300 by breaking down quantum circuit 300 into alternating sequences of CNOT gates 302. Each CNOT sequence creates a layer of qubit functional configuration. The sequence of layers defines the unique type of quantum circuit. In one embodiment, decomposing engine 202 utilizes various software tools to identify the unique circuit layers 304 of quantum circuit 300 in this manner, such as, but are not limited to, Cirq®, QuCAT, Qiskit®, etc.

In one embodiment, a circuit layer with a structure that is to be hidden from an attacker is buried in a denser circuit layer that is identical logically. As a result, in one embodiment, circuit layers, such as circuit layers 304A-304C, are matched with template circuit layers 305A-305C, respectively. Template circuit layers 305A-305C may collectively or individually be referred to as template circuit layers 305 or template circuit layer 305, respectively. Template circuit layer 305 in a quantum circuit, as used herein, is s sequence of quantum gates that is repeated. In one embodiment, such template layers 305 contain the decompositions discussed above.

For instance, CNOT gate 302′ in circuit layer 304A is decomposed into 3 CNOT gates 302″″ with Rz-SX-Rz-SX-Rz gates (Rz quantum gates 306, SX quantum gates 307) in between. In one embodiment, such a decomposition occurs in template circuit layer 305A of power-attack resistant quantum circuit 308.

In another example, CNOT gate 302″ is decomposed into 3 CNOT gates 302″″′ with Rz-SX-Rz-SX-Rz gates (Rz quantum gates 306, SX quantum gates 307) in between. In one embodiment, such a decomposition occurs in template circuit layer 305B of power-attack resistant quantum circuit 308.

In a further example, CNOT gate 302″′ is decomposed into 3 CNOT gates 302″″″ with Rz-SX-Rz-SX-Rz gates (Rz quantum gates 306, SX quantum gates 307) in between. In one embodiment, such a decomposition occurs in template circuit layer 305C of power-attack resistant quantum circuit 308.

In one embodiment, decomposing engine 202 recompiles the unique circuit layers 304 into template circuit layers 305 so that CNOT gates 302′, 302″, and 302″ of unique circuit layers 304 are intermixed with the decomposed CNOT gates 302″″, 302″″′, and 302″″″ as shown in FIGS. 3A-3C.

In one embodiment, decomposing engine 202 transforms the target quantum circuit (e.g., target quantum circuit 300) into a power-attack resistant quantum circuit (e.g., power-attack resistant quantum circuit 308) by encoding the proprietary information, such as the circuit structure, in the virtual quantum gates by transpiling the target quantum circuit into a sequence of 1-qubit and 2-qubit gates of the power-attack resistant quantum circuit. The power-attack resistant quantum circuit is then made to follow regular layers, such as having each layer be a maximal matching on the hardware graph. In one embodiment, the power-attack resistant quantum circuit is made to follow regular layers by inserting 2-qubit identity operations to make the layers full. Furthermore, decomposing engine 202 collects 2-qubit operations and writes them as generic SU(4) gates (SU(4) is a particular unitary group) in every layer. Each SU(4) gate is decomposed using the universal decomposition [SU(2)⊗SU(2)]CX [SU(2)⊗SU(2)]CX [SU(2)⊗SU(2)]CX [SU(2)⊗SU(2)]. It is noted that all two-qubit operations now have the same form (even the identity operation). Decomposing engine 202 further collects 1-qubit operations and writes them as generic SU(2) gates (SU(2) is a particular unitary group). Such SU(2) gates are decomposed using the universal decomposition RZ. SX. RZ. SX. RZ thereby resulting in an obfuscated circuit. Such a circuit has the same pulses regardless of the underlying computation.

In one embodiment, in addition to obfuscating, the non-virtual quantum gates required for obfuscation may reduce the fidelity (measure of the accuracy and reliability of a qubit or a quantum operation) of the computation when gates are noisy. As a result, there may be a tradeoff between security and fidelity of the quantum circuit. Hence, the target quantum circuit may be partially obfuscated so as to maintain the fidelity of the quantum circuit. In one embodiment, decomposing engine 202 still uses the canonical decomposition for the gate in the target quantum circuit but also randomly adds the canonical identity 401 sparsely as shown in FIGS. 4A-4C. Canonical identity 401, as used herein, refers to the operations of the circuit structure of the target quantum circuit, such as target quantum circuit 300, that are not obfuscated.

As shown in FIGS. 4A-4C, decomposing engine 202 randomly adds canonical identity 401 sparsely in order to not obfuscate such a portion of the circuit structure of the target quantum circuit, such as target quantum circuit 300, so as to maintain fidelity of the quantum circuit. For example, only a portion of the circuit structure of the target quantum circuit may be obscured as opposed to the entirety of the target quantum circuit so as to not introduce too much noise due to quantum gates being noisy.

For proprietary information corresponding to the measurement outcome, in one embodiment, decomposing engine 202 transforms the target quantum circuit into a power-attack resistant quantum circuit by encoding the proprietary information, such as a measurement outcome, in virtual quantum gates by randomly inserting X gates before measurement operations, where each X gate is decomposed into alternating layers of virtual quantum gates and non-virtual quantum gates (e.g., Rz-SX-Rz-SX-Rz, where Rz quantum gates are virtual quantum gates and SX quantum gates are non-virtual quantum gates) as discussed below in connection with FIGS. 5A-5C.

Referring to FIGS. 5A-5C, measurement outcomes are determined by measurements performed by measurement operations. Measurement outcomes are binary strings that contain proprietary information. In one embodiment, decomposing engine 202 utilizes a one-time pad (i.e., adding another known binary string to hide the results) to encrypt the measurements using the computational circuit. In such an embodiment, the quantum circuit does not change.

For example, FIG. 5A illustrates target quantum circuit 500 with a Hadamard (H) gate 501 and CNOT gates 502, the measurements of which are evaluated by measurement operations 503. Decomposing engine 202 transforms target quantum circuit 500 into power-attack resistant quantum circuit 505 by applying the X gate 504 before the measurements thereby flipping the bits in the measurement outcome as shown FIGS. 5B and 5C. Furthermore, each X gate 504 is decomposed into alternating layers of virtual quantum gates (e.g., Rz quantum gates 306) and non-virtual quantum gates (SX quantum gates 307) as previously discussed in connection with FIGS. 3A-3C.

Prior to retrieving such measurements, decomposing engine 202 flips the results locally after retrieving them thereby providing the appropriate measurements.

For proprietary information corresponding to the initial product state of the qubits, in one embodiment, decomposing engine 202 transforms the target quantum circuit into a power-attack resistant quantum circuit by encoding the proprietary information, such as the initial product state of the qubits, in virtual quantum gates by inserting X gates which are decomposed into alternating layers of virtual quantum gates and non-virtual quantum gates as discussed below in connection with FIGS. 6A-6B.

Referring to FIGS. 6A-6B, the initial state of the qubit may contain proprietary information, such as test data. In one embodiment, decomposing engine 202 obfuscates such proprietary information from power side-channel attacks by inserting X gates at the beginning of the target quantum, which are decomposed into alternating layers of virtual quantum gates and non-virtual quantum gates to obfuscate the initial basis of each qubit.

For instance, FIG. 6A illustrates target quantum circuit 600 with a Hadamard (H) gate 601 and CNOT gates 602, the measurements of which are evaluated by measurement operations 603. Decomposing engine 202 transforms target quantum circuit 600 into power-attack resistant quantum circuit 605 by inserting X gates 604, at the beginning of target quantum circuit 600, which are decomposed into alternating layers of virtual quantum gates (e.g., Rz quantum gates 306) and non-virtual quantum gates (SX quantum gates 307) as previously discussed in connection with FIGS. 3A-3C. By utilizing virtual quantum gates which do not use power, the proprietary information, such as the initial state of the qubit, is protected from theft by a power side-channel attack.

However, since in this embodiment, X gates 604 are utilized, the corresponding bits in the input are flipped. As a result, in such an embodiment, decomposing engine 202 changes the definition of 0 and 1 for those input bits that where flipped by X gates 604 in order to obtain the correct measurements by measurement operations 603. Furthermore, in such an embodiment as shown in FIGS. 6A-6B, the quantum circuit does not change.

For proprietary information corresponding to the parameters to be bound in the quantum circuit, in one embodiment, decomposing engine 202 transforms the target quantum circuit into a power-attack resistant quantum circuit by encoding the proprietary information, such as the parameters to be bound in the quantum circuit, in virtual quantum gates by decomposing each parameterized gate into a series of quantum gates including a virtual quantum gate as discussed below in connection with FIGS. 7A-7B.

Referring to FIGS. 7A-7B, in certain cases, the values of the parameters to be bound in the quantum circuit contain proprietary information, such as via rotation angles corresponding to Hamiltonian coefficients, which point to which systems are being simulated. In one embodiment, decomposing engine 202 protects such parameters from being exposed by a power side-channel attack by folding them into a virtual gate.

For example, as shown in FIG. 7A, target quantum circuit 700 includes parameterized quantum gates 701, such as ZZ gates, which use a single parameter, θ, to set the phase of entanglement between two qubits (e.g., qubits q₀ and q₁). To protect the values of the parameters from parameterized quantum gates 701 that are to be bound in the quantum circuit from being exposed due to the power side-channel attack, decomposing engine 202 transforms target quantum circuit 700 into power-attack resistant quantum circuit 705 by decomposing each parameterized gate 701 into a series of quantum gates 702, including non-virtual quantum gates (e.g., CNOT gates 703) and a virtual quantum gate (e.g., Rz quantum gate 704), in power-attack resistant quantum circuit 705 thereby making parameters power attack-resistant. Such parameters are not subject to being exposed by a power side-channel attack since such virtual quantum gates do not use power.

In this manner, proprietary information encoded in the quantum circuits is prevented from being stolen by power side-channel attacks.

Furthermore, the principles of the present disclosure improve the technology or technical field involving quantum computing.

As discussed above, the interest in quantum computing is growing rapidly and already a large number of quantum computers are easily accessible over the Internet to researchers and everyday users. Due to the expensive nature of the quantum computing equipment, these computers are currently available as cloud-based systems. Remote access makes it easy for different users and companies to run algorithms on real quantum computers without the need to purchase or maintain them. However, there is a threat of malicious insiders within the data centers or cloud computing facilities to access the quantum computers and the microwave controllers (device that uses microwaves to control quantum bits or qubits) thereby leveraging physically collected information to steal or leak the proprietary information in the quantum circuits. One such method is using what is referred to as “power side-channel attacks,” such as on the quantum computer controllers (e.g., microwave controllers). Power side-channel attacks are a type of physical attack that can be used to extract proprietary information (any type of data that the owner wishes to restrict who knows about it or its contents). These attacks exploit the control pulses from the quantum computer controllers (e.g., microwave controllers) that quantum computers use to execute gate operations, which are fully classical and can be monitored. For example, attackers can measure the power consumption of the controller devices that send the microwave pulses to the quantum computer. The measured power consumption enables the attacker to recover information about the control pulses, which can then be used to reverse engineer proprietary information (e.g., algorithms being run, structure of quantum circuit) encoded in the quantum circuit executed on the quantum hardware. For example, the attacker may use per-channel single trace information to perform a brute-force attack with the goal of reconstructing the quantum program. Unfortunately, there is not currently a means for preventing the theft of proprietary information encoded in quantum circuits executed on quantum hardware.

Embodiments of the present disclosure improve such technology by receiving the target quantum circuit and the identification of the proprietary information of the target quantum circuit to be obscured. The target quantum circuit, as used herein, refers to the quantum circuit desired to have its proprietary information protected from power side-channel attacks. Proprietary information, as used herein, refers to any type of data that the owner wishes to restrict who knows about it or its contents. Examples of proprietary information include, but are not limited to, a circuit structure, a measurement outcome, an initial product state of qubits, and parameters to be bound in the target quantum circuit. The target quantum circuit is transformed into a power-attack resistant quantum circuit by encoding the proprietary information in virtual quantum gates. The proprietary information is encoded in virtual quantum gates in various manners depending upon the particular proprietary information to be obscured. Virtual quantum gates, as used herein, refer to quantum gates which are not executed on quantum hardware whose logical effects are tracked classically. Such virtual quantum gates require no power. Examples of virtual quantum gates include, but are not limited to, the X gate, the Rx gate, the Rz gate, and the SWAP gate. As a result, proprietary information encoded in the virtual quantum gates cannot be detected via a power side-channel attack. In this manner, proprietary information encoded in quantum circuits is prevented from being stolen by power side-channel attacks. Furthermore, in this manner, there is an improvement in the technical field involving quantum computing.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for obscuring proprietary information encoded in quantum circuits, the method comprising:
receiving a target quantum circuit;
receiving an identification of said proprietary information of said targeted quantum circuit to be obscured; and
transforming said target quantum circuit into a power-attack resistant quantum circuit by encoding said proprietary information in virtual quantum gates which are not executed on quantum hardware whose logical effects are tracked classically.

2. The method as recited in claim 1, wherein said proprietary information comprises one of the following in the group consisting of: a circuit structure, a measurement outcome, an initial product state of qubits, and parameters to be bound in said target quantum circuit.

3. The method as recited in claim 1, wherein said virtual quantum gates encode a circuit structure of said target quantum circuit by converting said target quantum circuit into dense layers of two-qubit and one-qubit gates, wherein said dense layers of two-qubit and one-qubit gates are formed by:
inserting two-qubit gates to form a two-qubit dense layer; and
inserting dense one-qubit layers of alternating virtual quantum gates and non-virtual quantum gates to ensure said power-attack resistant quantum circuit is identical to said target quantum circuit.

4. The method as recited in claim 1, wherein said virtual quantum gates encode a measurement outcome by randomly inserting X gates before one or more measurement operations, wherein each X gate is decomposed into alternating layers of virtual quantum gates and non-virtual quantum gates.

5. The method as recited in claim 1, wherein said virtual quantum gates encode an initial product state of qubits by inserting X gates at a beginning of said target quantum circuit which are decomposed into alternating layers of virtual quantum gates and non-virtual quantum gates to obfuscate an initial basis of each qubit.

6. The method as recited in claim 1, wherein said virtual quantum gates encode parameters to be bound in said target quantum circuit by decomposing each parameterized gate into a series of quantum gates comprising a virtual quantum gate.

7. The method as recited in claim 1, wherein said virtual quantum gates comprise one of the following in the group consisting of: an X gate, an Rx gate, an Rz gate, and a SWAP gate.

8. A computer program product for obscuring proprietary information encoded in quantum circuits, the computer program product comprising one or more computer readable storage mediums having program code embodied therewith, the program code comprising programming instructions for:
receiving a target quantum circuit;
receiving an identification of said proprietary information of said targeted quantum circuit to be obscured; and
transforming said target quantum circuit into a power-attack resistant quantum circuit by encoding said proprietary information in virtual quantum gates which are not executed on quantum hardware whose logical effects are tracked classically.

9. The computer program product as recited in claim 8, wherein said proprietary information comprises one of the following in the group consisting of: a circuit structure, a measurement outcome, an initial product state of qubits, and parameters to be bound in said target quantum circuit.

10. The computer program product as recited in claim 8, wherein said virtual quantum gates encode a circuit structure of said target quantum circuit by converting said target quantum circuit into dense layers of two-qubit and one-qubit gates, wherein said dense layers of two-qubit and one-qubit gates are formed by:
inserting two-qubit gates to form a two-qubit dense layer; and
inserting dense one-qubit layers of alternating virtual quantum gates and non-virtual quantum gates to ensure said power-attack resistant quantum circuit is identical to said target quantum circuit.

11. The computer program product as recited in claim 8, wherein said virtual quantum gates encode a measurement outcome by randomly inserting X gates before one or more measurement operations, wherein each X gate is decomposed into alternating layers of virtual quantum gates and non-virtual quantum gates.

12. The computer program product as recited in claim 8, wherein said virtual quantum gates encode an initial product state of qubits by inserting X gates at a beginning of said target quantum circuit which are decomposed into alternating layers of virtual quantum gates and non-virtual quantum gates to obfuscate an initial basis of each qubit.

13. The computer program product as recited in claim 8, wherein said virtual quantum gates encode parameters to be bound in said target quantum circuit by decomposing each parameterized gate into a series of quantum gates comprising a virtual quantum gate.

14. The computer program product as recited in claim 8, wherein said virtual quantum gates comprise one of the following in the group consisting of: an X gate, an Rx gate, an Rz gate, and a SWAP gate.

15. A system, comprising:
a memory for storing a computer program for obscuring proprietary information encoded in quantum circuits; and
a processor connected to said memory, wherein said processor is configured to execute program instructions of the computer program comprising:
receiving a target quantum circuit;
receiving an identification of said proprietary information of said targeted quantum circuit to be obscured; and
transforming said target quantum circuit into a power-attack resistant quantum circuit by encoding said proprietary information in virtual quantum gates which are not executed on quantum hardware whose logical effects are tracked classically.

16. The system as recited in claim 15, wherein said proprietary information comprises one of the following in the group consisting of: a circuit structure, a measurement outcome, an initial product state of qubits, and parameters to be bound in said target quantum circuit.

17. The system as recited in claim 15, wherein said virtual quantum gates encode a circuit structure of said target quantum circuit by converting said target quantum circuit into dense layers of two-qubit and one-qubit gates, wherein said dense layers of two-qubit and one-qubit gates are formed by:
inserting two-qubit gates to form a two-qubit dense layer; and
inserting dense one-qubit layers of alternating virtual quantum gates and non-virtual quantum gates to ensure said power-attack resistant quantum circuit is identical to said target quantum circuit.

18. The system as recited in claim 15, wherein said virtual quantum gates encode a measurement outcome by randomly inserting X gates before one or more measurement operations, wherein each X gate is decomposed into alternating layers of virtual quantum gates and non-virtual quantum gates.

19. The system as recited in claim 15, wherein said virtual quantum gates encode an initial product state of qubits by inserting X gates at a beginning of said target quantum circuit which are decomposed into alternating layers of virtual quantum gates and non-virtual quantum gates to obfuscate an initial basis of each qubit.

20. The system as recited in claim 15, wherein said virtual quantum gates encode parameters to be bound in said target quantum circuit by decomposing each parameterized gate into a series of quantum gates comprising a virtual quantum gate.
